(19) United States
(12) Patent Application Publication
(10) Pub. No.: US 2015/0256264 A1
(43) Pub. Date: Sep. 10, 2015

(54) System and Method for Chromatic Dispersion Tolerant Direct Optical Detection

(71) Applicant: FutureWei Technologies, Inc., Plano, TX (US)

(72) Inventors: Chen Chen, Ottawa (CA); Chuandong Li, Ottawa (CA); Zhuhong Zhang, Ottawa (CA)

(73) Assignee: FutureWei Technologies, Inc., Plano, TX (US)

(21) Appl. No.: 14/201,553

(22) Filed: Mar. 7, 2014

(51) Int. Cl. H04B 10/564; H04B 10/516

(52) U.S. Cl. CPC H04B 10/564; H04B 10/516

(57) ABSTRACT

Embodiments are provided to improve direct detection for optical transmissions. In an embodiment, a method by a transmitter includes adjusting, using a nonlinear equalizer (NLE), a drive voltage for an optical modulator in accordance with a mapping between the drive voltage and an output of the optical modulator. The mapping is an inverse function of a nonlinear transfer function at the optical modulator between the output and to the drive voltage. The method further includes driving, using the adjusted drive voltage, the output of the optical modulator. The output is a single-side band (SSB) signal and is sufficiently linear with respect to the drive voltage for allowing direct detection at a receiver.

### TECHNICAL FIELD

The present invention relates to the field of optical communications, and, in particular embodiments, to a system and method for chromatic dispersion tolerant direct optical detection.

### BACKGROUND

Chromatic dispersion (CD) can result in frequency-dependent fading for double-side band (DSB) optical signal transmission when a direct detection receiver type is used. This fading effect can be circumvented by transmitting a single-side band (SSB) signal generated via digital signal processing (DSP). The SSB causes orthogonal frequency-division multiplexing (OFDM) subcarriers after direct detection to experience a frequency-dependent phase shift without CD. The frequency-dependent phase shift can then be compensated using a one-tap linear equalizer. To facilitate direct detection, the optical carrier is transmitted along with the SSB signal over the optical fiber. One method to generate this optical carrier is to use a DC bias voltage at the optical modulator at the transmitter. However, the presence of the DC bias causes the optical modulator to operate in a nonlinear region of its transfer function. This produces a non-ideal SSB signal and its transmission becomes no longer immune to the CD induced fading effect. Hence, the detection performance is severely degraded. There is a need for an improved transmission scheme that allows efficient CD tolerant direct optical detection.

### SUMMARY OF THE INVENTION

In accordance with an embodiment of the disclosure, a method by a transmitter for a direct detection optical transmission system includes adjusting, using a nonlinear equalizer (NLE), a drive voltage for an optical modulator in accordance with a mapping between the drive voltage and an output of the optical modulator. The mapping is an inverse function of a nonlinear transfer function at the optical modulator between the output and to the drive voltage. The method further includes driving, using the adjusted drive voltage, the output of the optical modulator. The output is a single-side band (SSB) signal and is sufficiently linear with respect to the drive voltage for allowing direct detection at a receiver.

In accordance with another embodiment of the disclosure, a method by a transmitter for a direct detection system includes generating, using digital signal processing (DSP), a digital signal for optical communications, and generating, according to the digital signal, a drive voltage for an optical modulator. The drive voltage is then adjusted in accordance with a mapping between the drive voltage and an output of the optical modulator. The mapping is an inverse nonlinear function of a transfer function of the optical modulator. The method further includes converting the adjusted drive voltage into an analog signal, and modulating, using the analog signal, the output of the optical modulator. The modulated output is sufficiently linear with respect to the drive voltage for allowing direct detection at a receiver.

In accordance with yet another embodiment of the disclosure, a transmitter for a direct detection system comprises an optical modulator, at least one processor coupled to two driving arms of the optical modulator, and a non-transitory computer readable storage medium storing programming for execution by the at least one processor. The programming includes instructions to adjust a drive voltage for the optical modulator in accordance with a mapping between the drive voltage and an output of the optical modulator. The mapping is an inverse function of a nonlinear transfer function at the optical modulator between the output and to the drive voltage. The programming includes further instructions to drive, using the adjusted drive voltage, the output of the optical modulator. The output is a SSB signal and is sufficiently linear with respect to the drive voltage for allowing direct detection at a receiver.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an optical transmission system that enables direct detection;

FIG. 2 illustrates a transmitter DSP for a direct detection optical transmission system;

FIG. 3 illustrates optical output amplitude versus (vs.) electrical drive voltage at different DS bias for a direct detection optical transmission system;

FIG. 4 illustrates an embodiment of an improved transmitter DSP design comprising a nonlinear equalizer (NLE);

FIG. 5 illustrates an embodiment of NLE mapping and its polynomial implementation;

FIG. 6 illustrates an embodiment of signal to noise ratio (SNR) vs. transmitter 3 dB bandwidth when using a nonlinear equalizer;

FIG. 7 illustrates an embodiment of bit error ratio (BER) vs. transmitter 3 dB bandwidth when using a nonlinear equalizer;

FIG. 8 illustrates an embodiment of a method for transmission allowing chromatic dispersion (CD) tolerant direct optical detection; and

FIG. 9 illustrates a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

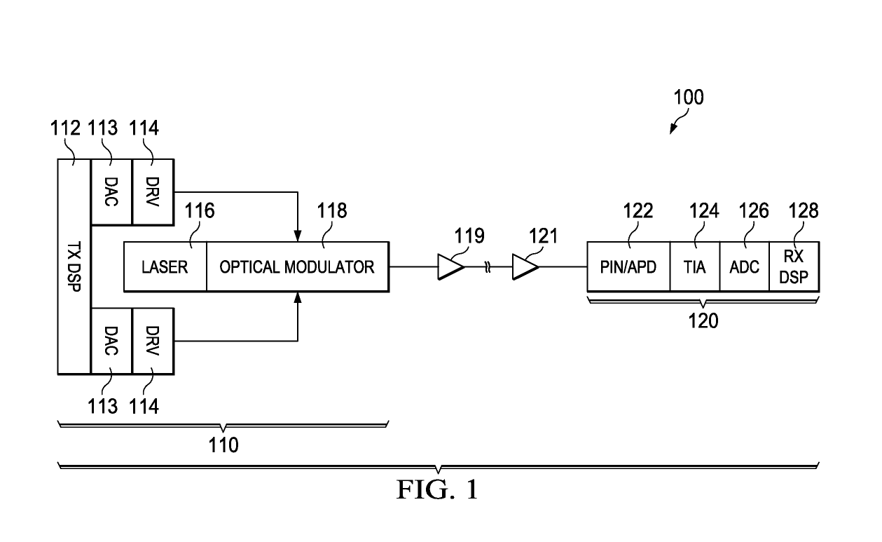

FIG. 1 shows an example of an optical orthogonal frequency-division multiplexing (OFDM) transmission system 100 that enables direct detection. The system 200 includes a transmitter 110 and a direct detection receiver 120, which are linked via an optical fiber. The transmitter 110 comprises a laser 116, an optical modulator 118 coupled to the output of the laser 116 to modulate the optical signals from the laser 116, and an optical amplifier 119 in front of the optical modulator 118. The optical modulator 118 is based on a Mach-Zehnder (MZ) interferometer design driven electrically by two arms. Each arm is coupled to a DSP unit 112 via a digital-to-analog converter (DAC) 113 and a radio frequency (RF) driver (DRV) 114. The direct detection receiver 120 includes a receiving optical amplifier 121 facing the transmitter 110, a PIN or avalanche photodiode (APD) 122 behind the receiving optical amplifier 121, an analog-to-digital converter (ADC) 126, a transimpedance amplifier (TIA) 124 between the PIN/APD 122 and the ADC 126, and a receiving DSP unit 128 coupled to the ADC 126.

Typically, OFDM transmissions with double-side band (DSB) from the transmitter 110 to the receiver 120 experience chromatic dispersion as they propagate via a fiber. This results in frequency-dependent fading and affects detection performance (increases signal errors). To overcome the fading effect due to CD, single-side band (SSB) signals are instead transmitted. As such, at the receiving DSP unit 128, OFDM subcarriers may only experience a frequency-dependent phase shift instead of the frequency-dependent fading. The frequency-dependent phase shift can then be compensated at the receiving DSP unit 128, for example, using a simple one-tap equalizer for instance.

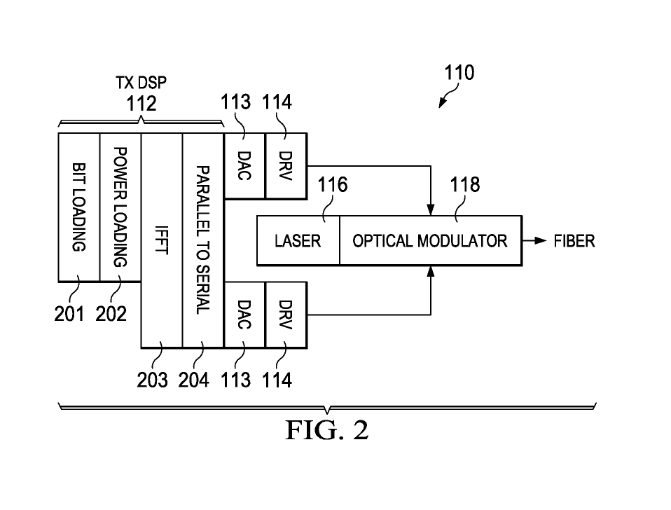

FIG. 2 shows the transmitter 110 including the DSP unit 112 with more details. The DSP unit 112 includes functional blocks for bit loading 201, power loading 202, inverse fast Fourier transform (IFFT) 203 or the like, and parallel to serial conversion 204. The bit and power loading are obtained using a water-filling algorithm, which optimizes the OFDM system performance. The DSP unit 112 generates the SSB signal, after the IFFT 203. The modulation is applied to either the positive or negative frequency subcarriers only, while the remaining subcarriers are zero-padded. The real and imaginary parts of the SSB signal are used to drive the two independent arms of the optical modulator 118 to realize electro-optical conversion. Examples of suitable optical modulators that can be used to generate the SSB signal include the dual-parallel MZ (DPMZ) and dual-drive MZ (DDMZ).

To facilitate direct detection, an optical carrier frequency is transmitted along with the SSB signal over the optical fiber, and is not suppressed as in other coherent optical transmission systems. This optical carrier can be generated by applying DC bias to the optical modulator 118 away from the null point. However, this DC bias scheme would force the optical modulator 118 to operate in the nonlinear region of its transfer function. As such, the resultant optical SSB signal becomes non-ideal and its transmission is no longer immune to the CD induced fading effect, which can severely degrade detection.

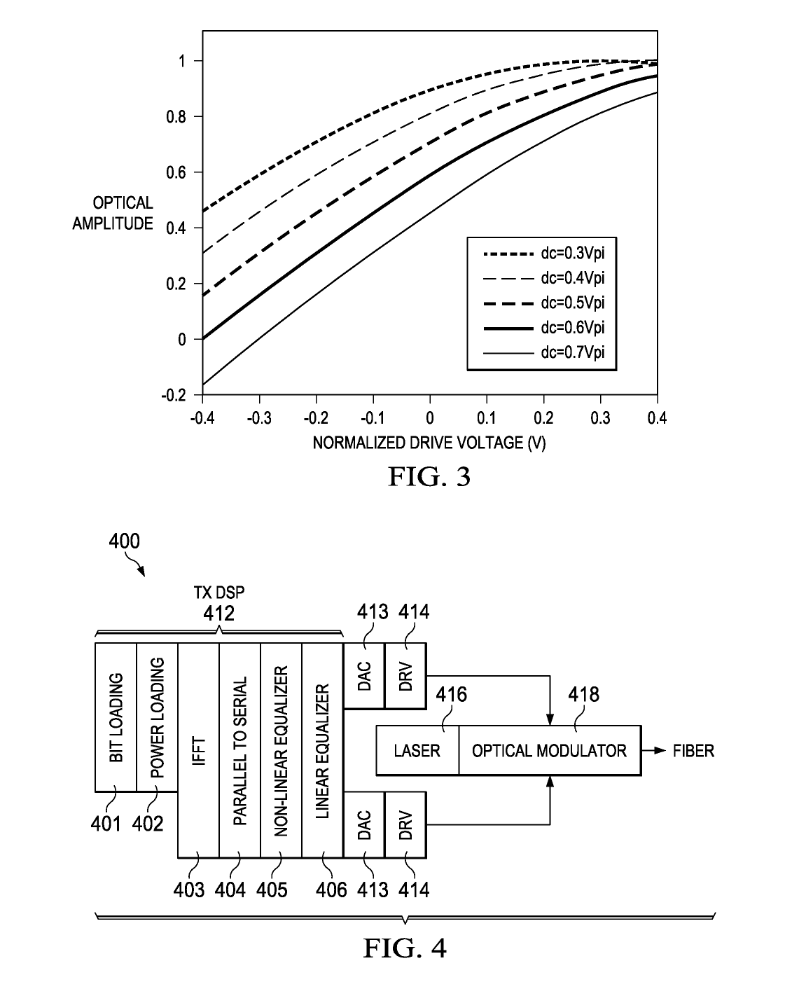

FIG. 3 is a graph showing an exemplary behavior of optical output amplitude vs. electrical drive voltage, which represents the modulator transfer function, at different DC bias values for the transmitter 110. The plotted data in the chart shows a simulation result. Specifically, the plot shows the modulation transfer function. The actual experimental transfer function can generally be well represented by this analytical (or simulation) result. The optical output is normalized against the maximum transmission amplitude. The electrical drive voltage is normalized against the modulator DC bias (Vpi) and is centered around zero voltage. It can be seen that modulator transfer function is not linear with respective to drive signal, which would cause distortion to the signal.

Embodiments are provided herein to resolve this issue and improve direct detection. The embodiments include using a transmitter-side digital precompensation scheme for direct detection optical transmission. The scheme comprises a transmitter-side nonlinear equalizer (NLE) that can reverse or reduce the nonlinear behavior of the modulator transfer function, and hence eliminate the fading effect and improve transmission performance. Using the NLE also avoids signal to noise ratio (SNR)/bit error ratio (BER) frequency-dependent fading and improves transmission performance. The scheme can be used to improve transmission capacity and/or error performance in the presence of residue and/or uncompensated CD from optical fiber transmission. Although the embodiments are described in context of OFDM signals, the embodiments herein can be applied and extended to other optical signals which can be digitally generated.

FIG. 4 shows an embodiment of an improved transmitter 400 for a direct detection system. For instance, the transmitter 400 can replace the transmitter 110 in the system 100 to improve system detection. The transmitter 400 comprises a DSP unit 412, a laser 416, an optical modulator 418 coupled to the laser 416 with two driving arms each coupled to the DSP unit 412 via a corresponding DAC 413 and a DRV 414. The DSP unit 412 includes functional blocks for bit loading 401, power loading 402, an IFFT 403 or the like, and parallel to serial conversion 404. The components above of the transmitter 400 operate similar to the respective components of the transmitter 110. The DSP unit 412 further includes two additional functional blocks: a NLE 405 subsequent to the functional block for parallel to serial conversion 404, and a linear equalizer 406 subsequent to the NLE 405. The linear equalizer 406 is coupled to the DACs 413 and drivers 414. The NLE 405 is used to control a nonlinear output of the transmitter with respect to driving voltage. The NLE 405 can be configured, using polynomial function parameters, to provide a deterministic modulator transfer function when the DC bias voltage for the optical modulator 418 is known. The NLE operation parameters can be determined offline and stored in memory for on-line operation.

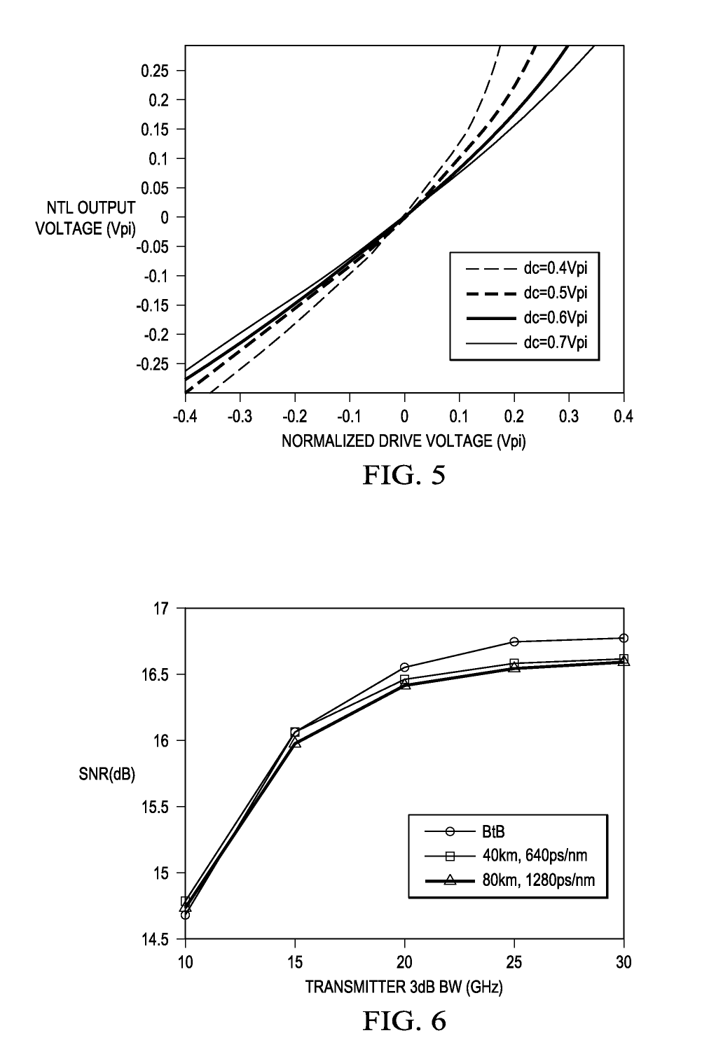

FIG. 5 is a graph illustrating an example of NLE implementation using a 3^{rd} order polynomial function, y=c1·x³+c2·x²+c3·x+c4. The graph shows four curves that represent four exact desired mappings between the normalized drive voltage and the output voltage of the optical modulator 418 for four given DC bias values (Vpi). The desired mappings are desired or target inverse functions by the NLE 405 to reverse the nonlinear behavior of the modulator transfer function, and hence achieve about linear relation between the drive voltage and the output of the optical modulator 418. The graph also shows four dashed line curves that represent the polynomial mappings for the four DC bias values. It can be seen that the polynomial mapping can approximate the exact mapping very well. Thus, by preconfiguring the NLE 405 using suitable polynomial parameters, the output voltage can be controlled to be linear or close to linear with respect to the drive voltage, per DC bias value. For example, a set of suitable polynomial parameters is used per each DC bias value.

However, one implementation concern of the design and scheme above is whether the frequency response, introduced by components of the transmitter 400, would reduce the effectiveness of the NLE 405 in controlling the transmitter output. For instance, each or any of the DAC 413, DRV 414, and optical modulator 418 can have a frequency response which causes a non-ideal mapping (of the NLE 405) when the signal arrives at the optical modulator 418. Due to the non-ideal mapping, some significant nonlinear behavior may still be present in the transmitter output.

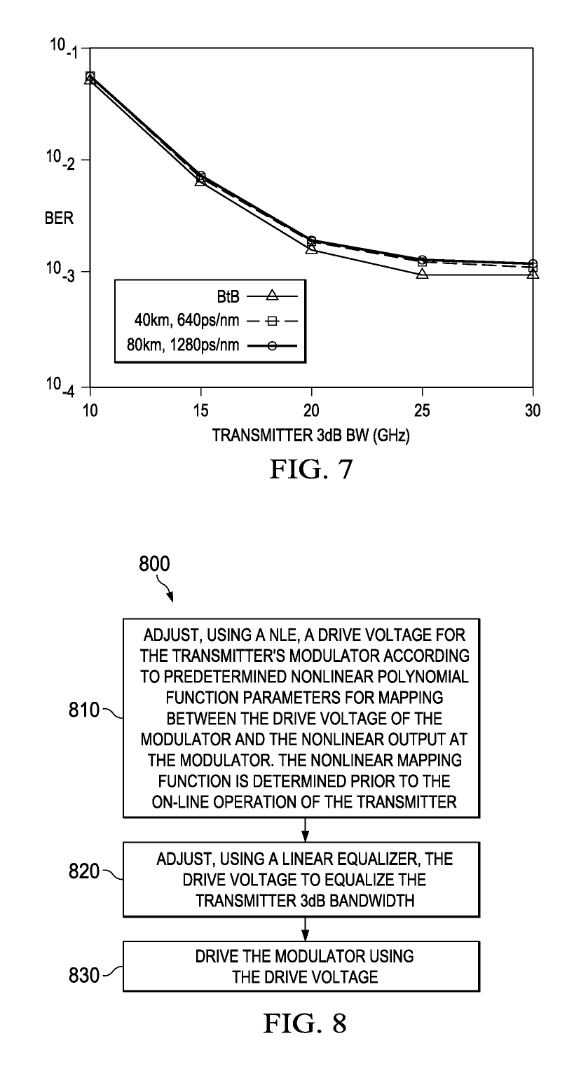

FIG. 6 is a graph showing SNR vs. transmitter 3 dB bandwidth for back-to-back (BtB), 40 km, and 80 km transmission distances using the transmitter 400. The transmitter's 3 dB bandwidth represents a combined frequency response of the DACs 413, DRVs 414 and optical modulator 418, and can be modeled as a 4^{th}-order Bessel function with different 3 dB bandwidth. FIG. 7 is a graph showing the corresponding BER result. FIGS. 6 and 7 show little SNR and BER difference between the BtB, 40 km and 80 km cases. This indicates that the modulator nonlinearity is effectively compensated, even though the reduced 3 dB bandwidth alters the nonlinear mapping (of the NLE 405). The SNR and BER difference at different 3 dB bandwidths are essentially due to bandwidth limitation. The linear equalizer 406 can be used in the transmitter 400 to perform bandwidth equalization, so that the nonlinear mapping is kept ideal or acceptable at the optical modulator 418. Alternatively, the NLE 405 can be effective even without using the linear equalizer 406 for linear bandwidth equalization when the transmitter's operating bandwidth is reduced.

FIG. 8 shows an embodiment of a method 800 for transmission allowing chromatic dispersion tolerant direct optical detection. The method 800 can be implemented using the transmitter 400 with the NLE 405. At step 810, a NLE (e.g., as part of DSP) adjusts the drive voltage or the transfer function for the modulator according to predetermined nonlinear polynomial function parameters for mapping between the drive voltage of the modulator and the nonlinear output at the modulator. The drive voltage determines which part of the transfer function the signal applies to. Thus, controlling the drive voltage can be equivalent to controlling the transfer function. The nonlinear mapping function can be predetermined for the NLE 405 prior to the on-line operation, e.g., for each desired DC bias. At step 820, a linear equalizer further adjusts the drive voltage to equalize the transmitter 3 dB bandwidth. At step 830, the modulator is driven using the drive voltage.

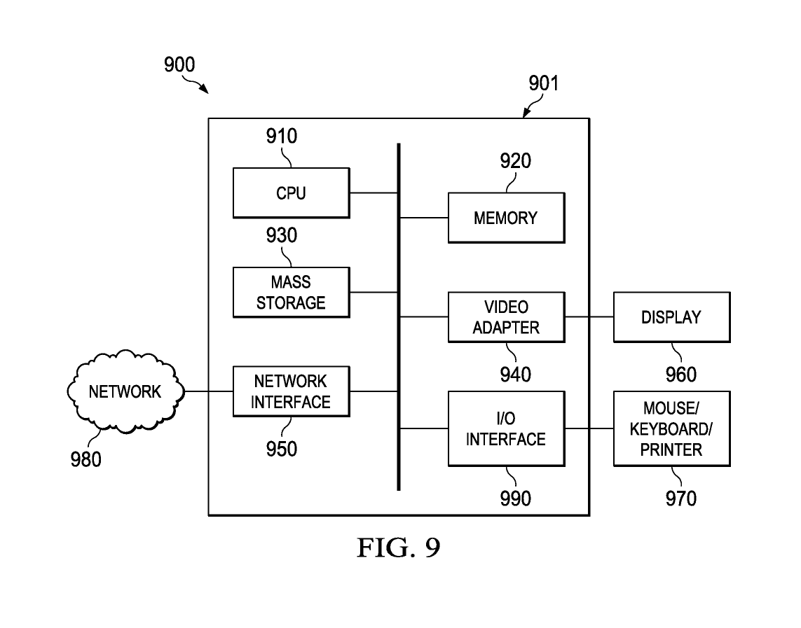

FIG. 9 is a block diagram of an exemplary processing system 900 that can be used to implement various embodiments. The processing system is part of any of the embodiment transmitter systems above, for instance to implement the DSP functions. The processing system 900 may comprise a processing unit 901 equipped with one or more input/output devices, such as a speaker, microphone, mouse, touchscreen, keypad, keyboard, printer, display, and the like. The processing unit 901 may include a central processing unit (CPU) 910, a memory 920, a mass storage device 930, a video adapter 940, and an Input/Output (I/O) interface 990 connected to a bus. The bus may be one or more of any type of several bus architectures including a memory bus or memory controller, a peripheral bus, a video bus, or the like.

The CPU 910 may comprise any type of electronic data processor. The memory 920 may comprise any type of system memory such as static random access memory (SRAM), dynamic random access memory (DRAM), synchronous DRAM (SDRAM), read-only memory (ROM), a combination thereof, or the like. In an embodiment, the memory 920 may include ROM for use at boot-up, and DRAM for program and data storage for use while executing programs. The mass storage device 930 may comprise any type of storage device configured to store data, programs, and other information and to make the data, programs, and other information accessible via the bus. The mass storage device 930 may comprise, for example, one or more of a solid state drive, hard disk drive, a magnetic disk drive, an optical disk drive, or the like.

The video adapter 940 and the I/O interface 990 provide interfaces to couple external input and output devices to the processing unit. As illustrated, examples of input and output devices include a display 960 coupled to the video adapter 940 and any combination of mouse/keyboard/printer 970 coupled to the I/O interface 990. Other devices may be coupled to the processing unit 901, and additional or fewer interface cards may be utilized. For example, a serial interface card (not shown) may be used to provide a serial interface for a printer.

The processing unit 901 also includes one or more network interfaces 950, which may comprise wired links, such as an Ethernet cable or the like, and/or wireless links to access nodes or one or more networks 980. The network interface 950 allows the processing unit 901 to communicate with remote units via the networks 980. For example, the network interface 950 may provide wireless communication via one or more transmitters/transmit antennas and one or more receivers/receive antennas. In an embodiment, the processing unit 901 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method by a transmitter for a direct detection optical transmission system, the method comprising:
adjusting, using a nonlinear equalizer (NLE), a drive voltage for an optical modulator in accordance with a mapping between the drive voltage and an output of the optical modulator, wherein the mapping is an inverse function of a nonlinear transfer function at the optical modulator between the output and to the drive voltage; and
driving, using the adjusted drive voltage, the output of the optical modulator, wherein the output is a single-side band (SSB) signal and is sufficiently linear with respect to the drive voltage for allowing direct detection at a receiver.

2. The method of claim 1, wherein the inverse function of the mapping is a polynomial function, and wherein the method further comprises predetermining a plurality of polynomial parameters for the polynomial function prior to operating the transmitter.

3. The method of claim 1 further comprising further adjusting, using a linear equalizer, the drive voltage, wherein the further adjusted drive voltage increases linearity of the output with respect to the drive voltage and equalizes a 3 dB bandwidth of the transmitter.

4. The method of claim 1 further comprising applying a DC bias voltage to the optical modulator, wherein the DC bias voltage introduces a carrier frequency in the output.

5. The method of claim 4 further comprising predetermining the mapping in accordance with the DC bias voltage.

6. The method of claim 1 further comprising selecting, according to a DC bias voltage for the optical modulator, the mapping from a plurality of predetermined mappings between the drive voltage and an output of the optical modulator corresponding to a plurality of DC bias values for the optical modulator.

7. The method of claim 1, wherein the SSB signal corresponds to a frequency-division multiplexing (OFDM) subcarrier.

8. The method of claim 1, wherein the NLE is a digital signal processing (DSP) function of the transmitter.

9. A method by a transmitter for a direct detection system, the method comprising:
generating, using digital signal processing (DSP), a digital signal for optical communications;
generating, according to the digital signal, a drive voltage for an optical modulator;
adjusting the drive voltage in accordance with a mapping between the drive voltage and an output of the optical modulator, wherein the mapping is an inverse nonlinear function of a transfer function of the optical modulator;
converting the adjusted drive voltage into an analog signal; and
modulating, using the analog signal, the output of the optical modulator, wherein the modulated output is sufficiently linear with respect to the drive voltage for allowing direct detection at a receiver.

10. The method of claim 9 further comprising further adjusting, using a linear equalizer, the drive voltage, wherein the further adjusted drive voltage increases linearity of the output with respect to the drive voltage and equalizes a 3 dB bandwidth of the transmitter.

11. The method of claim 9 further comprising limiting a bandwidth of the transmitter, wherein the limited bandwidth allows sufficient linearity of the output with respect to the drive voltage.

12. The method of claim 9, wherein generating the digital signal comprises performing power loading using a water filling algorithm.

13. The method of claim 9 further comprising applying a DC bias voltage to the optical modulator, wherein the DC bias voltage introduces a carrier frequency in the output.

14. The method of claim 13 further comprising predetermining the mapping in accordance with the DC bias voltage.

15. A transmitter for a direct detection system, the transmitter comprising:
an optical modulator;
at least one processor coupled to two driving arms of the optical modulator; and
a non-transitory computer readable storage medium storing programming for execution by the at least one processor, the programming including instructions to:
adjust a drive voltage for the optical modulator in accordance with a mapping between the drive voltage and an output of the optical modulator, wherein the mapping is an inverse function of a nonlinear transfer function at the optical modulator between the output and to the drive voltage; and
drive, using the adjusted drive voltage, the output of the optical modulator, wherein the output is a single-side band (SSB) signal and is sufficiently linear with respect to the drive voltage for allowing direct detection at a receiver.

16. The transmitter of claim 15, wherein the inverse function of the mapping is a polynomial function having a plurality of polynomial parameters predetermined prior to operating the transmitter.

17. The transmitter of claim 15, wherein the programming includes further instructions to further adjust the drive voltage using a linear equalizer function, wherein the further adjusted drive voltage increases linearity of the output with respect to the drive voltage and equalizes a 3 dB bandwidth of the transmitter.

18. The transmitter of claim 15, wherein the programming includes further instructions to apply a DC bias voltage to the optical modulator, wherein the DC bias voltage introduces a carrier frequency in the output.

19. The transmitter of claim 18, wherein the mapping is predetermined in accordance with the DC bias voltage.

20. The transmitter of claim 18, wherein the SSB signal corresponds to a frequency-division multiplexing (OFDM) subcarrier, and wherein the processor is a digital signal processor.
